(19) United States
(12) Patent Application Publication
(10) Pub. No.: US 2026/0091687 A1
(43) Pub. Date: Apr. 2, 2026

(54) ELECTRIC VEHICLE

(71) Applicants: TOYOTA JIDOSHA KABUSHIKI KAISHA, Toyota-shi Aichi-ken (JP); AISIN CORPORATION, Kariya Aichi-ken (JP)

(72) Inventors: Toshihiro YAMAMOTO, Toyota-shi Aichi-ken (JP); Toshifumi YAMAKAWA, Toyota-shi Aichi-ken (JP); Yoshiaki ITO, Kariya Aichi-ken (JP); Yuki NAGANO, Kariya Aichi-ken (JP); Yuki KUREBAYASHI, Kariya Aichi-ken (JP)

(73) Assignees: TOYOTA JIDOSHA KABUSHIKI KAISHA, Toyota-shi Aichi-ken (JP); AISIN CORPORATION, Kariya Aichi-ken (JP)

(21) Appl. No.: 19/341,735

(22) Filed: Sep. 26, 2025

(30) Foreign Application Priority Data
Oct. 1, 2024 (JP) 2024-172391

(51) Int. Cl. B60L 15/08; B60L 15/20; H02P 21/20; H02P 27/06

(52) U.S. Cl. CPC B60L 15/08; B60L 15/20; H02P 21/20; H02P 27/06; B60L 2210/42; B60L 2240/421; B60L 2240/423

(57) ABSTRACT

An electric vehicle includes a motor, an inverter configured to drive the motor, and a controller configured to perform pulse torque control by controlling the inverter based on a control torque command having a pulse period defined by the sum of a non-zero torque duration and a zero torque duration. The controller is configured to make a pulse frequency, which is the reciprocal of the pulse period, variable when performing the pulse torque control.

### CROSS-REFERENCE TO RELATED APPLICATION

The present disclosure claims priority to Japanese Patent Application No. 2024-172391 filed on Oct. 1, 2024, which is incorporated herein by reference in its entirety including specification, drawings and claims.

### TECHNICAL FIELD

The present disclosure relates to an electric vehicle.

### BACKGROUND

Conventionally, a pulse controller configured to perform pulse torque control of a motor has been proposed, wherein a technique selectively adjusts at least one of a frequency, an amplitude, or a duty cycle of pulses (see, for example, Patent Document 1).

### CITATION LIST

### Patent Literature

PTL 1: JP2024-508586A

### SUMMARY

In an electric vehicle equipped with a pulse controller, when the pulse controller performs the above technique, if frequency component that is an integer multiple (e.g., 1 time, 2 times, etc.) of the pulse frequency, which is the reciprocal of a pulse period (the sum of the pulse-on time and the pulse-off time) in pulse torque control, are relatively large, there is concern that vibration and noise of the vehicle may increase due to superposition between a frequency that is an integer multiple of the pulse frequency and a resonance frequency of the vehicle.

The main object of the electric vehicle according to the present disclosure is to suppress an increase in vibration and noise of the vehicle.

In order to achieve the above main object, the electric vehicle according to the present disclosure employs the following configuration.

An electric vehicle according to the present disclosure is an electric vehicle includes a motor, an inverter configured to drive the motor, and a controller configured to perform pulse torque control by controlling the inverter based on a control torque command having a pulse period defined by the sum of a non-zero torque duration and a zero torque duration. The controller is configured to make a pulse frequency, which is the reciprocal of the pulse period, variable when performing the pulse torque control.

In the electric vehicle according to the present disclosure, the controller performs the pulse torque control by controlling the inverter based on the control torque command having the pulse period defined by the sum of the non-zero torque duration and the zero torque duration. Then, the controller makes the pulse frequency, which is the reciprocal of the pulse period, variable when performing the pulse torque control. Such a configuration enables the electric vehicle according to the present disclosure to suppress an increase in frequency component that is an integer multiple (e.g., 1 time, 2 times, etc.) of the pulse frequency compared to when the pulse frequency is constant. As a result, the electric vehicle according to the present disclosure is able to suppress an increase in vibration and noise of the vehicle even when the frequency that is the integer multiple of the pulse frequency overlaps with the resonance frequency of the vehicle.

In the electric vehicle according to the present disclosure, the controller may be configured to randomly vary the pulse frequency when performing the pulse torque control.

In the electric vehicle according to the present disclosure, the controller may be configured to switch the pulse frequency among a plurality of frequencies at each allowable duration that varies randomly when performing the pulse torque control.

In the electric vehicle according to the present disclosure, the controller may be configured to set a torque amplitude based on a DC side voltage of the inverter and a rotational speed of the motor, and when a required torque of the motor is less than the torque amplitude, the controller may be configured to perform the pulse torque control based on a torque duty, which is obtained by dividing the torque amplitude by the required torque, and the pulse frequency.

### BRIEF DESCRIPTION OF DRAWINGS

FIG. 1 is a schematic configuration diagram of a battery electric vehicle according to an embodiment of a present disclosure.

FIG. 2 is a flowchart showing an example of a processing routine executed by an ECU.

FIG. 3A is an explanatory diagram showing an example of waveforms of a required torque of a motor and an output torque of the motor.

FIG. 3B is an explanatory diagram showing an example of a frequency spectrum of the output torque when the ECU performs pulse torque control according to a comparative example.

FIG. 4A is an explanatory diagram showing an example of waveforms of a required torque of the motor and an output torque of the motor.

FIG. 4B is an explanatory diagram showing an example of a frequency spectrum of the output torque when the ECU performs pulse torque control according to the embodiment.

FIG. 5 is a flowchart showing an example of a processing routine of the modification.

FIG. 6A is an explanatory diagram showing an example of waveforms of a required torque of the motor and an output torque of the motor.

FIG. 6B is an explanatory diagram showing an example of a frequency spectrum of the output torque when the ECU performs pulse torque control according to a modification.

### DESCRIPTION OF EMBODIMENTS

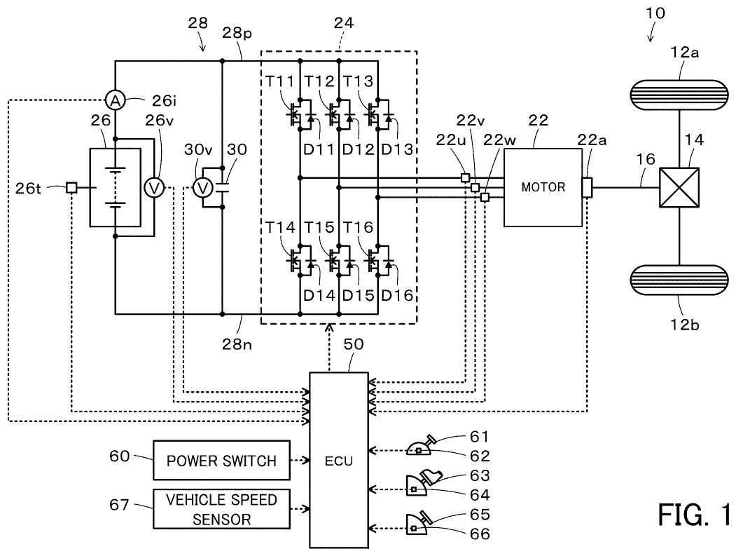

Embodiments according to the present disclosure will be described with reference to the drawings. FIG. 1 is a schematic configuration diagram of a battery electric vehicle 10 according to an embodiment of the present disclosure. As shown in the drawing, the battery electric vehicle 10 according to the embodiment includes a motor 22, an inverter 24, a battery 26, and an electronic control unit (hereinafter referred to as “ECU”) 50.

The motor 22 is configured as a three-phase AC motor and includes a rotor with permanent magnets embedded in a rotor core and a stator with three-phase (U-phase, V-phase, and W-phase) coils wound around the stator core. The rotor of motor 22 is connected to a drive shaft 16 connected to drive wheels 12a and 12b via a differential gear 14.

The inverter 24 is connected to a power line 28 (positive line 28p and negative line 28n) to which the battery 26 is connected. The inverter 24 includes six transistors T11 to T16 as switching elements and six diodes D11 to D16, each connected in parallel with the respective transistor T11 to T16. The transistors T11 to T16 are arranged in pairs, each pair comprising two transistors that serve as a source side and a sink side with respect to the positive line 28p and the negative line 28n. Each connection point between the two transistors in each pair of T11 to T16 is connected to a corresponding one of the three-phase (U-phase, V-phase, and W-phase) coils of the motor 22. Accordingly, by adjusting the on-time ratio of each pair of transistors T11 to T16 by the ECU 50, a rotating magnetic field is formed in the three-phase coils of the motor 22, thereby rotationally driving the motor 22 (rotor).

The battery 26 is configured, for example, as a lithium-ion secondary battery or a nickel-metal hydride secondary battery. A positive terminal and a negative terminal of the battery 26 are connected to the power line 28. A smoothing capacitor 30 is connected to the power line 28.

The ECU 50 includes a microcomputer, various drive circuits, and various logic ICs. The microcomputer includes a CPU, ROM, RAM, flash memory, input/output ports, and communication ports. The ECU 50 receives signals from various sensors. For example, the ECU 50 receives the rotational position θm of the rotor of the motor 22 from a rotational position sensor 22a, and phase currents Iu, Iv, and Iw of each phase of the motor 22 from current sensors 22u, 22v, and 22w. The ECU 50 also receives a voltage Vb of the battery 26 from a voltage sensor 26v, a current Ib of the battery 26 from a current sensor 26i, a temperature Tb of the battery 26 from a temperature sensor 26t, and a voltage VH of the capacitor 30 (power line 28) from a voltage sensor 30v. The ECU 50 also receives an on/off signal from a power switch 60, a shift position SP indicating an operation position of a shift lever 61 from a shift position sensor 62, an accelerator opening Acc indicating a depression amount of an accelerator pedal 63 from an accelerator pedal position sensor 64, a brake pedal position BP indicating a depression amount of a brake pedal 65 from a brake pedal position sensor 66, and a vehicle speed V from a vehicle speed sensor 67. The ECU 50 outputs switching control signals to transistors T11 to T16 of the inverter 24. The ECU 50 calculates an electrical angle θe and a rotational speed Nm of the motor 22 based on the rotational position Om of the rotor of the motor 22. The ECU 50 also calculates a state of charge (SOC) of the battery 26 based on an integrated value of the battery current Ib.

In the battery electric vehicle 10 according to the embodiment, the ECU 50 sets a required torque Td* for driving (torque required at the drive shaft 16) based on the accelerator opening Acc and the vehicle speed V. The ECU 50 sets a required torque Tmrq of the motor 22 such that the vehicle is driven in accordance with the required torque Td*. The ECU 50 sets a control torque command Tm* based on the required torque Tmrq. The ECU 50 performs switching control of the transistors T11 to T16 of the inverter 24 based on the control torque command Tm*.

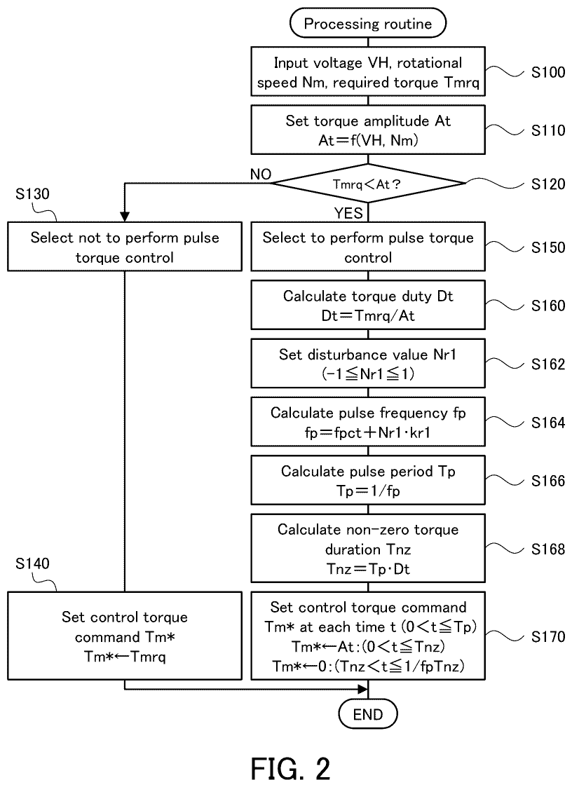

Next, the operation of the battery electric vehicle 10 according to the embodiment, particularly the process of setting the control torque command Tmc, will be described. FIG. 2 is a flowchart showing an example of a processing routine executed by the ECU 50. This routine is repeatedly executed.

When this routine is executed, the ECU 50 inputs the voltage VH of the capacitor 30 (power line 28), the rotational speed Nm of the motor 22, and the required torque Tmrq of the motor 22 (step S100). Then, the ECU 50 sets torque amplitude At in pulse torque control based on the voltage VH of the capacitor 30, the rotational speed Nm of the motor 22, and a torque amplitude map (step S110). The pulse torque control is control that controls the inverter 24 based on the control torque command Tm* having a pulse period defined by the sum of a non-zero torque time and a zero torque time. The torque amplitude map is predetermined, for example, through experiments, analysis, or the like, as a relationship between the voltage VH of the capacitor 30, the rotational speed Nm of the motor 22, and the torque amplitude At. The ECU 50 applies the voltage VH of the capacitor 30 and the rotational speed Nm of the motor 22 to the torque amplitude map and derives the corresponding torque amplitude At.

The ECU 50 compares the required torque Tmrq of the motor 22 with the torque amplitude At (step S120). This process is a process that selects whether to perform or not to perform the pulse torque control. When the ECU 50 determines that the required torque Tmrq of the motor 22 is equal to or greater than the torque amplitude At, the ECU 50 selects not to perform the pulse torque control (step S130). In this case, the ECU 50 sets the control torque command Tm* of the motor 22 to the required torque Tmrq (step S140) and terminates the routine.

In step S120, when the ECU 50 determines that the required torque Tmrq of the motor 22 is less than the torque amplitude At, the ECU 50 selects to perform the pulse torque control (step S150). In this case, the ECU 50 executes the process of steps S160 to S170 and terminates the routine. The process of steps S160 to S170 is described below.

The ECU 50 calculates a torque duty Dt in the pulse torque control by dividing the required torque Tmrq of the motor 22 by the torque amplitude At (step S160). The ECU 50 sets a disturbance value Nr1 within a range of −1 or more and 1 or less (step S162). The ECU 50 calculates a pulse frequency fp in the pulse torque control as the sum of a basic frequency fpct and a product of the disturbance value Nr1 and a coefficient kr1 (step S164). The basic frequency fpct and the coefficient kr1 are predetermined.

The ECU 50 calculates a pulse period Tp as the reciprocal of the pulse frequency fp (step S166). The ECU 50 calculates a non-zero torque duration Tnz in the pulse torque control as the product of the pulse period Tp and the torque duty Dt (step S168). The ECU 50 sets the control torque command Tm* of the motor 22 at each time t in a time range where the time t is greater than 0 and less than or equal to the pulse period Tp (step S170). Specifically, the ECU 50 sets the control torque command Tm* of the motor 22 to the torque amplitude At in a time range where the time t is greater than 0 and less than or equal to the non-zero torque duration Tnz. Furthermore, the ECU 50 sets the control torque command Tm* of the motor 22 to 0 in a time range where the time t exceeds the non-zero torque duration Tnz and is less than or equal to the pulse period Tp.

Through such processing, the pulse frequency fp (pulse period Tp) randomly varies at each time the processing routine shown in FIG. 2 is executed. Such a configuration enables the battery electric vehicle 10 according to the embodiment to suppress an increase in frequency component that is an integer multiple (e.g., 1 time, 2 times, etc.) of the pulse frequency fp compared to when the pulse frequency fp is constant. As a result, the battery electric vehicle 10 is able to suppress an increase in vibration and noise of the vehicle even when the frequency that is the integer multiple of the pulse frequency fp overlaps with the resonance frequency of the vehicle.

In order to suppress the increase in vibration and noise of the vehicle, the ECU 50 may set the pulse frequency fp so as to avoid superposition of the frequency that is the integer multiple of the pulse frequency fp overlaps and the resonance frequency of the vehicle. However, the resonance frequency of the vehicle varies depending on the number of passengers, the weight of the vehicle, the ambient temperature, the road surface conditions, the traveling conditions, and so on. For this reason, setting the pulse frequency fp requires a large amount of information and a large amount of process. In contrast, by setting the pulse frequency fp by the ECU 50 as in the embodiment, it is possible to suppress the increase in vibration and noise of the vehicle in a simple manner.

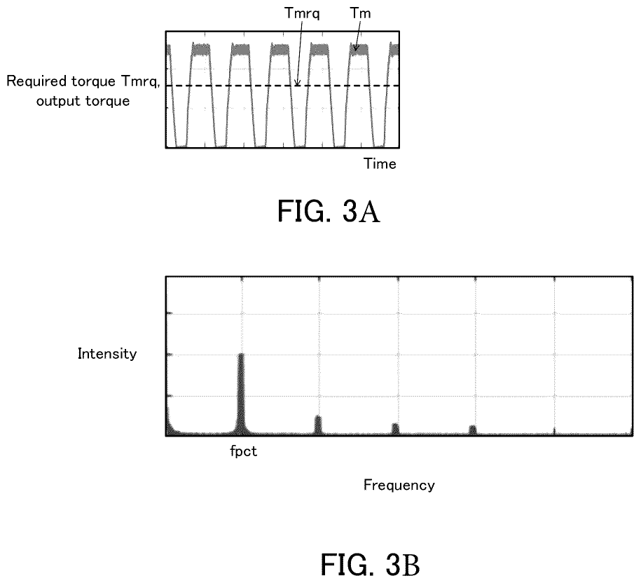

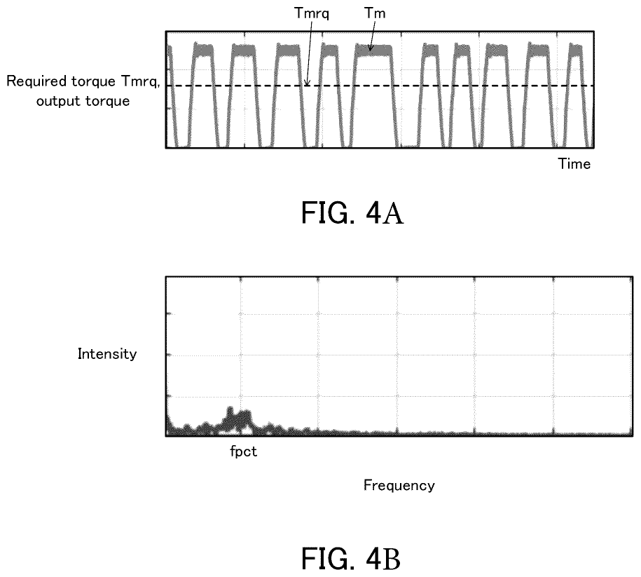

FIG. 3A is an explanatory diagram showing an example of waveforms of a required torque Tmrq of the motor 22 and an output torque Tm of the motor 22, and FIG. 3B is an explanatory diagram showing an example of a frequency spectrum of the output torque Tm when the ECU 50 performs pulse torque control according to a comparative example. FIG. 4A is an explanatory diagram showing an example of waveforms of the required torque Tmrq of the motor 22 and an output torque Tm of the motor 22, and FIG. 4B is an explanatory diagram showing an example of a frequency spectrum of the output torque Tm when the ECU 50 performs the pulse torque control according to the embodiment. FIGS. 3A and 4A respectively show an example of the waveforms of the required torque Tmrq and the output torque Tm, and FIGS. 3B and 4B respectively show an example of the frequency spectrum of the output torque Tm. The vertical and horizontal axis scales in FIGS. 3A and 4A are common, and the vertical and horizontal axis scales in FIGS. 3B and 4B are also common. In the comparative example, the pulse frequency fp is fixed at the basic frequency fpct of the embodiment.

Here, the output torque Tm is estimated, for example, based on d-axis and q-axis currents Id and Iq and an output torque estimation map. The d-axis and q-axis currents Id and Iq are obtained by performing coordinate transformation (three-phase to two-phase transformation) on the phase currents Iu, Iv, and Iw using the electrical angle θe. The output torque estimation map is predetermined, for example, through experiments, analysis, or the like, as a relationship between the d-axis and q-axis currents Id and Iq and the output torque Tm. The frequency spectrum of the output torque Tm is obtained, for example, by performing a Fourier transform on the output torque Tm.

As shown in FIGS. 3B and 4B, when the frequency spectra of the output torques Tm of the comparative example and the embodiment are compared, the intensity of the basic frequency fpct of the embodiment is smaller than that of the basic frequency fpct of the comparative example. Thus, the battery electric vehicle 10 according to the embodiment is able to suppress the increase in vibration and noise of the vehicle even when the frequency of the output torque Tm of the motor 22 and the resonance frequency of the vehicle overlap each other.

As described above, in the battery electric vehicle 10 according to the embodiment, the ECU 50 randomly varies the pulse frequency fp when performing the pulse torque control. Such a configuration enables the battery electric vehicle 10 to suppress the increase in the frequency component that is the integer multiple (e.g., 1 time, 2 times, etc.) of the pulse frequency fp compared to when the pulse frequency is constant. As a result, the battery electric vehicle 10 is able to suppress the increase in vibration and noise of the vehicle even when the frequency that is the integer multiple of the pulse frequency overlaps with the resonance frequency of the vehicle.

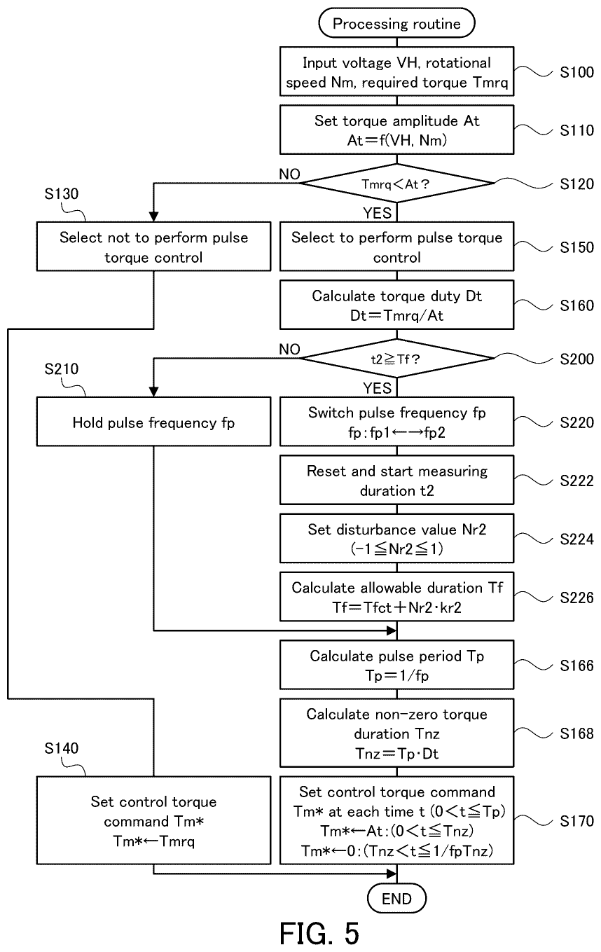

In the embodiment described above, the ECU 50 executes the processing routine shown in FIG. 2. Alternatively, the ECU 50 may execute the processing routine shown in FIG. 5. The processing routine shown in FIG. 5 differs from the processing routine shown in FIG. 2 in that the processes of steps S162 and S164 are replaced with the processes of steps S200 to S226. Accordingly, for those processes in the processing routine shown in FIG. 5 that are the same as those in the processing routine shown in FIG. 2, the same step numbers are used and detailed description thereof is omitted. In this modification, when the ECU 50 executes the processing routine shown in FIG. 5 for the first time after system startup, the ECU 50 sets the pulse frequency fp to a frequency f1, sets an allowable duration Tf of the pulse frequency fp to a time Tf1, and starts measuring a duration t2 of the pulse frequency fp. The frequency f1, a frequency f2 described later, and the time Tf1 are predetermined.

In the processing routine shown in FIG. 5, after the ECU 50 calculates the torque duty Dt in step S160, the ECU 50 compares the duration t2 of the pulse frequency fp with the allowable duration Tf (step S200). When the ECU 50 determines that the duration t2 of the pulse frequency fp is less than the allowable duration Tf, the ECU 50 holds the pulse frequency fp (step S210) and proceeds to step S166.

When the ECU 50 determines that the duration t2 of the pulse frequency fp is longer than or equal to the allowable duration Tf in step S200, the ECU 50 switches the pulse frequency fp between frequencies fp1 and fp2 (step S220). The ECU 50 resets the duration t2 of pulse frequency fp and starts measuring the duration t2 (step S222). The ECU 50 sets a disturbance value Nr2 within a range of −1 or more and 1 or less (step S224). The ECU 50 calculates the allowable duration Tf of the pulse frequency fp as the sum of a basic duration Tfct and a product of the disturbance value Nr2 and a coefficient kr2 (step S226), and proceeds to step S166. The basic duration Tfc and the coefficient kr2 are predetermined.

Through such processing, the pulse frequency fp switches between the frequencies fp1 and fp2 at each allowable duration Tf that varies randomly. Such a configuration enables the battery electric vehicle 10 according to the modification to suppress the increase in frequency component that is the integer multiple (e.g., 1 time, 2 times, etc.) of the pulse frequency fp compared to when the pulse frequency fp is constant or when the pulse frequency fp switches between the frequencies fp1 and fp2 at a fixed duration. As a result, the battery electric vehicle 10 is able to suppress an increase in vibration and noise of the vehicle even when the frequency that is the integer multiple of the pulse frequency fp overlaps with the resonance frequency of the vehicle.

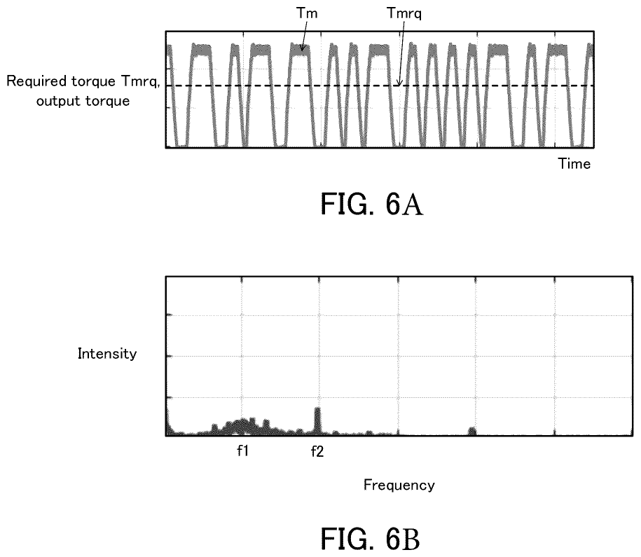

FIG. 6A is an explanatory diagram showing an example of waveforms of a required torque Tmrq of the motor 22 and an output torque Tm of the motor 22, and FIG. 6B is an explanatory diagram showing an example of a frequency spectrum of the output torque Tm when the ECU 50 performs the pulse torque control according to the modification. FIG. 6A shows an example of the waveforms of the required torque Tmrq and the output torque Tm, and FIG. 6B shows an example of the frequency spectrum of the output torque Tm. The vertical and horizontal axes scales in FIGS. 3A and 6A are common, and the vertical and horizontal axes scales in FIGS. 3B and 6B are also common.

As shown in FIGS. 3B and 6B, when the frequency spectra of the output torques Tm of the comparative example and the modification are compared, the intensities of the frequencies f1 and f2 of the modification are smaller than that of the basic frequency fpct of the comparative example. Thus, the battery electric vehicle 10 according to the modification is able to suppress the increase in vibration and noise of the vehicle even when the frequency of the output torque Tm of the motor 22 and the resonance frequency of the vehicle overlap each other.

In the modification, the ECU 50 switches the pulse frequency fp between two frequencies fp1 and fp2 at allowable duration Tf that vary randomly. However, this is not limited to this. For example, the ECU 50 may switch the pulse frequency fp between three or more frequencies at each allowable duration Tf that varies randomly.

In the embodiment described above, the configuration is that of the battery electric vehicle 10 including the motor 22 and the inverter 24. However, the present disclosure is not limited thereto. For example, the configuration may be that of a hybrid electric vehicle further including an engine, in addition to a hardware configuration similar to that of the battery electric vehicle 10. Alternatively, the configuration may be that of a fuel cell electric vehicle including a fuel cell, in addition to a hardware configuration similar to that of the battery electric vehicle 10.

The correspondence between the main elements of the embodiment and the main elements of the disclosure described in the Summary section will be described. In the embodiment, the motor 22 corresponds to the “motor”, the inverter 24 corresponds to the “inverter”, and the ECU 50 corresponds to the “controller”.

It should be noted that the correspondence between the main elements of the embodiment and the main elements of the disclosure described in the Summary section is provided solely as an example to specifically illustrate one possible mode of implementing the disclosure. Therefore, the elements of the disclosure described in the Summary section should not be construed as being limited by the embodiment. In other words, the interpretation of the disclosure should be based on the description in the Summary section, and the embodiment merely represents a specific example of the disclosure described therein.

While the present disclosure has been described above with reference to the embodiment as an example of one mode of implementation, the present disclosure is not limited to the embodiment. Various modifications and variations may be made to the embodiment without departing from the scope and spirit of the present disclosure.

### INDUSTRIAL APPLICABILITY

The technique of the present disclosure is applicable to the manufacturing industries of the electric vehicles and so on.

What is claimed is:

1. An electric vehicle comprising:
a motor;
an inverter configured to drive the motor; and
a controller configured to perform pulse torque control by controlling the inverter based on a control torque command having a pulse period defined by the sum of a non-zero torque duration and a zero torque duration,
wherein the controller is configured to make a pulse frequency, which is the reciprocal of the pulse period, variable when performing the pulse torque control.

2. The electric vehicle according to claim 1,
wherein the controller is configured to randomly vary the pulse frequency when performing the pulse torque control.

3. The electric vehicle according to claim 1,
wherein the controller is configured to switch the pulse frequency among a plurality of frequencies at each allowable duration that varies randomly when performing the pulse torque control.

4. The electric vehicle according to claim 1,
wherein the controller is configured to set a torque amplitude based on a DC side voltage of the inverter and a rotational speed of the motor, and when a required torque of the motor is less than the torque amplitude, the controller is configured to perform the pulse torque control based on a torque duty, which is obtained by dividing the torque amplitude by the required torque, and the pulse frequency.
